(19) United States
(12) Patent Application Publication
(10) Pub. No.: US 2022/0318658 A1
(43) Pub. Date: Oct. 6, 2022

(54) AI-ACCELERATED CHARACTERIZATION OF MATERIALS

(71) Applicant: STOICHEIA, INC., Skokie, IL (US)

(72) Inventors: Andrey IVANKIN, Chicago, IL (US); Jordan H. SWISHER, Chicago, IL (US); Michael J. ASHLEY, Chicago, IL (US)

(21) Appl. No.: 17/713,416

(22) Filed: Apr. 5, 2022

Related U.S. Application Data
(60) Provisional application No. 63/171,038, filed on Apr. 5, 2021.

(51) Int. Cl. G06N 5/04; G06K 9/62; G01N 21/01; G01N 23/02; G01N 21/84

(52) U.S. Cl. CPC G06N 5/046; G06K 9/6257; G01N 21/01; G01N 23/02; G01N 21/84; G06N 20/00

(57) ABSTRACT

Devices, systems, and methods for material characterization can include detecting definitional data from material samples that are positionally encoded according to know attributes as operational data, characterizing at least some of the samples as training data, and processing the training data via a machine learning model to train the model and/or to characterize the remaining samples based on the training data.

### CROSS-REFERENCE

This utility application claims priority to U.S. Provisional Patent Application No. 63/171,038, entitled AI-ACCELERATED CHARACTERIZATION OF MATERIALS, filed on Apr. 5, 2022, the contents of which are hereby incorporated by reference in their entirety.

### FIELD

The present disclosure concerns devices, systems, and methods for characterization of materials. More specifically, the present disclosure concerns devices, systems, and methods for artificial intelligence (AI) based characterization of materials.

### SUMMARY

The present application discloses one or more of the features recited in the appended claims and/or the following features which, alone or in any combination, may comprise patentable subject matter.

According to an aspect of the present disclosure, a method of characterizing a material collection may include positionally encoding a set of material samples on at least one substrate according to known physical, chemical, and/or treatment attributes as operational data; detecting definitional data from at least some of the material samples as definitional samples; correlating the definitional data with the operational data; and characterizing at least some of the definitional samples as training data based on correlation of the definitional and the operational data. In some embodiments, the method may include inputting the characterization training data to a machine learning model and outputting characterization of at least a portion of the set of material samples other than the definitional samples, based on the characterization training data.

In some embodiments, characterizing at least some of the definitional samples as training data may include determining, by the machine learning model, a location on the at least one substrate of a next-material sample for characterization as training data. Determining the location on the at least one substrate of a next-material sample for characterization as training data may include determining a predicted output, determining an experimental output, and comparing the predicted and experimental outputs to determine a predictive error value, and determining a confidence value for predictive output of each of the material samples based on the predictive error value.

In some embodiments, determining the location on the at least one substrate of the next-material sample for characterization may include determination of the location on the at least one substrate of the next-material sample to increase the confidence value by the greatest amount. Characterizing at least some of the definitional samples as training data may be determined to be complete upon reaching a predetermined threshold confidence value. In some embodiments, determining the location on the at least one substrate of a next-material sample for characterization as training data may include entering the training data into the machine learning model and outputting a next-location for detection and a predicted output of the corresponding sample, and detecting definitional data of the next-material sample and comparing the detected definitional data with the predicted output.

In some embodiments, physical, chemical, and/or treatment attributes as operational data may include one or more of: precursor gradient among material samples across the at least one substrate, chemical constituent gradient among material samples across the at least one substrate, and treatment gradient by exposure to irradiation with different wavelengths among material samples across the at least one substrate. Detecting definitional data may include determining one or more of catalytic activity, electrochemical activity, chemical product distribution resultant from reaction, elemental distribution and/or geometry, mechanical-physical properties, thermal properties, optical properties, catalytic and/or corrosion evolution, and/or fluorescence intensity.

In some embodiments, the method may further include determining one or more physical, chemical, and/or treatment attributes of a next material collection for further characterization. Detecting definitional data may further include obtaining definitional data concerning material samples of another known material collection as at least some of the definitional samples. The material samples may each be defined on the nano- or micro-scale. Detecting definitional data from at least some of the material samples may include moving between material samples at the nano- or micro-scale.

According to another aspect of the present disclosure, a material collection characterization system may include a data collection system comprising at least one sensor configured to detect definitional data from at least some material samples of a set of material samples as definitional samples, wherein the material samples are positionally encoded on at least one substrate according to known physical, chemical, and/or treatment attributes as operational data; and a characterization control system comprising at east one processor configured to execute instructions stored on memory to conduct characterization of the set of material samples on the at least one substrate. The characterization control system may be configured to operate the data collection system to detect definitional data from at least some of the material samples as definitional samples, to correlate the definitional data with the operational data, and to characterize at least some of the definitional samples as training data based on the correlation of extracted definitional and operational data, wherein the characterization control system includes a machine learning model configured to receive the characterization training data as input, and to output characterization of at least a portion of the set of material samples other than the definitional samples, based on the characterization training data.

In some embodiments, configuration to characterize at least some of the definitional samples as training data may include configuration to determine, by the machine learning model, a location on the at least one substrate of a next-material sample for characterization as training data. Configuration to determine the location on the at least one substrate of a next-material sample for characterization as training data may include configuration to determine a predicted output, to determine an experimental output, and to compare the predicted and experimental outputs for determining a predictive error value, and to determine a confidence value for predictive output of each of the material samples based on the predictive error value. Configuration to determine the location on the at least one substrate of the next-material sample for characterization may include configuration to determine the location on the at least one substrate of the next-material sample for increasing the confidence value by the greatest amount.

In some embodiments, characterization of at least some of the definitional samples as training data may be determined to be complete upon reaching a predetermined threshold confidence value. Configuration to determine the location on the at least one substrate of a next-material sample for characterization as training data may include entering the training data into the machine learning model and outputting a next-location for detection and a predicted output of the corresponding sample, detecting definitional data of the sample and comparing the detected definitional data with the predicted output. In some embodiments, physical, chemical, and/or treatment attributes as operational data may include one or more of: precursor gradient among material samples across the at least one substrate, chemical constituent gradient among material samples across the at least one substrate, and treatment gradient by exposure to irradiation with different wavelengths among material samples across the at least one substrate.

In some embodiments, configuration to detect definitional data may include configuration to determine one or more of catalytic activity, electrochemical activity, chemical product distribution resultant from reaction, elemental distribution and/or geometry, mechanical-physical properties, thermal properties, optical properties, catalytic and/or corrosion evolution, and/or fluorescence intensity. The characterization control system may be further configured to determine one or more parameters of a next material collection for further characterization.

In some embodiments, configuration to detect definitional data may further include obtaining definitional data concerning material samples of another known material collection as at least some of the definitional samples. The material samples may each be defined on the nano- or micro-scale. Configuration to detect definitional data from at least some of the material samples may include configuration to position the data collection system to collect data of different material samples at the nano- or micro-scale.

According to another aspect of the present disclosure, a method of characterizing a material chip may include detecting definitional data from material samples as definitional samples, the material samples positionally encoded on a substrate according to known physical, chemical, and/or treatment attributes as operational data; correlating the definitional data with the operational data, including correlating based on definitional data obtained from another material chip having materials samples positionally encoded on a substrate according to known physical, chemical, and/or treatment attributes as operational data; and characterizing at least some of the definitional samples as training data based on correlation of the definitional and the operational data. The method may include inputting the characterization training data to a machine learning model and outputting characterization of at least a portion of the set of material samples other than the definitional samples, based on the characterization training data.

Additional features, which alone or in combination with any other feature(s), including those listed above and those listed in the claims, may comprise patentable subject matter and will become apparent to those skilled in the art upon consideration of the following detailed description of illustrative embodiments exemplifying the best mode of carrying out the invention as presently perceived.

### BRIEF DESCRIPTION

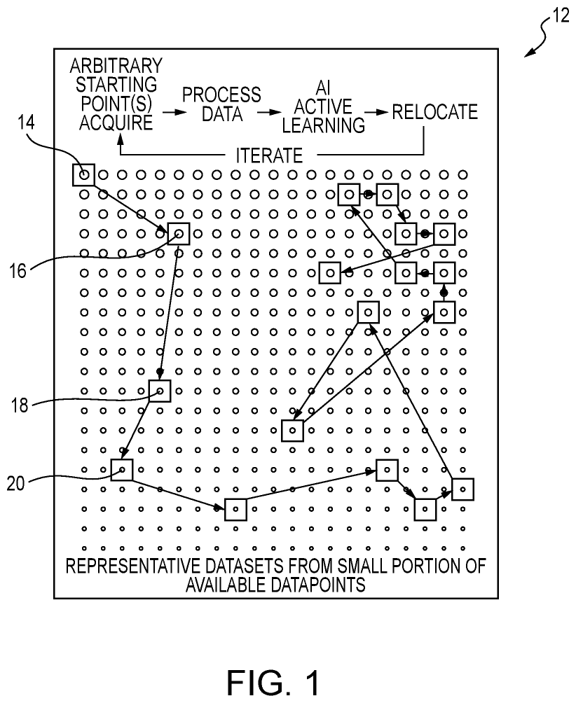

FIG. 1 is a diagrammatic view of an exemplary path of consideration of some of the samples of a set of material samples in order to conduct characterization of the broader set of material samples by machine learning, showing that informed selection of the sample set can reduce uncertainty in the characterization of the broader set of material samples;

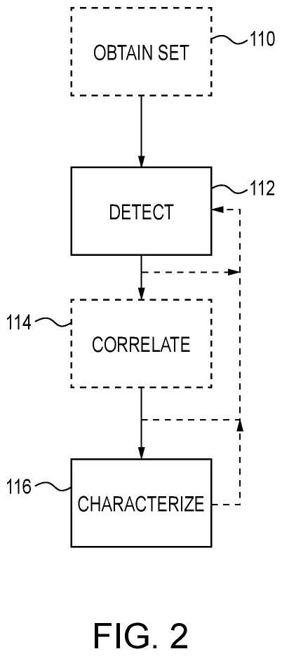

FIG. 2 is a flow diagram illustrating operations for characterization of materials in accordance with aspects of the present disclosure; and

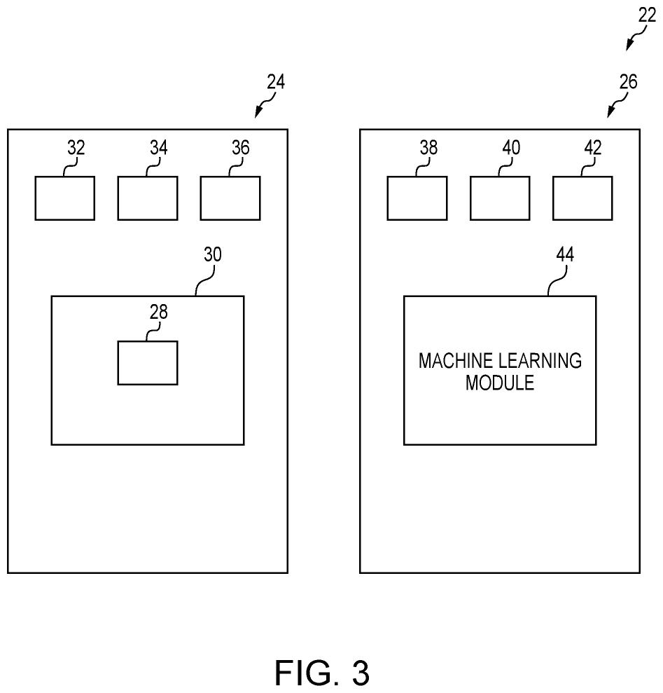

FIG. 3 is a diagrammatic view of a material characterization system in accordance with aspects of the present disclosure.

### DETAILED DESCRIPTION

Achieving a sustainable economy while continuing to foster economic growth may include radical advances in materials. For example, such advances could be in the materials used for catalyzing green processes such as hydrogen production via electrolysis, converting CO₂ into value-added chemicals and fuels, harvesting solar energy, and/or efficiently storing clean energy in batteries. Large challenges can be faced in these areas. For example, current computational and/or experimental materials discovery strategies can be extremely slow and/or ineffective for searching through the seemingly endless materials genome.

Chemists and materials scientists have traditionally relied on a brute force approach by iterating on previous results for years before achieving significant advances. Artificial intelligence (AI)-guided design of new materials has not cured these challenges. The lack of large-scale, high-quality training datasets on structure-function relationships in nanomaterials has limited the effectiveness of AI-guided design of new materials. Addressing these issues may be of paramount importance for building a sustainable future and/or maintaining the trend of advancement in materials-based technologies.

The present disclosure includes devices, systems, and methods for materials discovery. For example, devices, systems, and methods within the present disclosure can implement materials libraries or even ‘megalibrary’ technology to significantly accelerate the process of material discovery. In one non-limiting example, the process may include the synthesis of suitable libraries or megalibraries, in which many (e.g., millions of) multimetallic nanoparticles, each of which having different size and/or composition by design. In such a library or megalibrary sample, nanoparticles may be positionally encoded onto a chip. Such encoding may be performed by chemical vapor deposition (CVD), electron beam evaporation, thermal evaporation, and/or polymer pen lithography (PPL), as disclosed in U.S. Pat. No. 9,372,397, the contents of which are hereby incorporated by reference in their entirety, including but not limited to those portions concerning deposition of materials. Such chips can be loaded into characterization machines, for example, a scanning electron microscope (SEM) or scanning droplet electrochemical cell, to extract structural and/or functional insights about the material candidates.

Characterizing each individual material from an extremely large library (for example, a library of millions of nanoparticles) is an immense (nearly impossible) task. For example, consider that such individual material characterization may apply high-resolution techniques which can take tens of minutes to sufficiently characterize a single nanoparticle.

Within the present disclosure, machine learning (ML) can be applied to achieve guided materials screening. For example, combining automation with active ML and Bayesian Optimization (BO) can assist in guiding materials screening. Following acquisition of an initial training set, for example, comprised of tens to hundreds of data points, devices, systems, and methods within the present disclosure may define guidance for the characterization. For example, the AI-based controller may, in real time, define which candidate (or a batch of candidates) to characterize next for machine learning and rapid discovery of new materials.

Such guidance may be directed to any manner of desired functionalities, for example, catalytic activity/selectivity, stability, luminescence, etc. While active ML in materials discovery may have been previously attempted, such attempts can be constrained by iterative synthesis of each material candidate suggested by the algorithm. However, applying ‘megalibraries’ can alleviate the challenges of individual candidate synthesis by making all possible candidates available as already pre-synthesized on a chip. The AI-based controller may access the material library or megalibrary for characterization on-demand. Such arrangements can dramatically reduce the time and/or cost for building predictive algorithms and/or to identify new catalysts and/or other materials with superior performance.

A need exists for discovery of new materials at a faster rate than ever before to maintain economic growth and to achieve a sustainable future. Yet, traditional approaches to materials discovery remain prohibitively slow and/or inefficient to face this challenge. High-throughput experimental (HTE) methods today may allow synthesis and screening of hundreds to thousands of candidates per week; but still represent merely a drop in the ocean compared to the estimated number of possibilities (e.g., >10⁶⁰). Modern density functional theory (DFT) and quantum chemistry simulation techniques are also extremely slow, require large computational loads, and are only capable of describing systems of limited complexity. The inability of the HTE methods to rapidly generate large-scale, high-quality training datasets for a wide variety of materials also greatly limits the potential of AI-guided materials design strategies.

Within the present disclosure, devices, systems, and methods can achieve dramatically accelerated materials discovery strategy by implementation of ‘megalibrary’ technology, for example, a ‘megalibrary’ provided by Stoicheia, Inc. of Skokie, Ill. Applying high-resolution and/or high-throughput additive printing tools to deposit discrete block-copolymer nanoreactors, rapid synthesizing of millions of multimetallic nanoparticles can be achieved. The nanoreactors can each be formed different in size and/or composition by design and positionally encoded onto a square-centimeter-scale chip.

A single ‘megalibrary’ chip can contain 3-5 orders of magnitude more material candidates than those of conventional HTE methods (for example, weekly production of conventional HTE methods). Additionally, application of a single megalibrary can enable access to material compositions and/or structures not readily achievable with current techniques, e.g., 7-element nanoparticles with a precisely controlled stoichiometry. Moreover, these materials can each be synthesized and/or screened under identical conditions. This consistent approach can reduce experiment-to-experiment variability and/or greatly improve the quality of collected data. Furthermore, the combination of advanced ML prediction techniques with such megalibraries presents additional advantages. For example, implemented with a ML approach, ‘megalibraries’ may also present a unique opportunity to overcome the bottlenecks of screening and/or AI training, as a single sample may contain all possible materials of interest (i.e. >90,000 unique materials per sample) already presynthesized. Combining megalibraries with an active ML approach, for example based on Bayesian Optimization (BO), one non-limiting approach selectively explores material candidates for characterization, but only evaluates the most promising nanoparticles. Such selective operation can significantly reduce the cost of characterization and/or future simulations compared with conventional evolutionary algorithms. Since ‘megalibraries’ already have all possible nanoparticles for the parameter space of interest pre-synthesized on a chip, the illustrative ML algorithm can access the most promising candidates on demand using automated characterization tools.

Within the present disclosure, the AI controller can be well-suited for both intra-experiment optimization in which automated screening processes can be greatly accelerated as an intelligent data-collection system through active learning which can enable efficient sampling to acquire representative datasets) and inter-experiment optimization (in which the AI controller can use these datasets to suggest the next synthesis experiment in order to design a better material). By automating and optimizing the typical bottleneck processes in screening large materials libraries, and generating datasets describing the structure (input) and properties (output) of nanomaterials that are sufficiently large to continually train ML algorithms, time and/or resources for searching the material space to find enhanced materials can be drastically reduced. This workflow can be transferrable, and/or can be applied across different materials and screening methodologies.

Material synthesis strategies are being pursued to advance material process evaluation. For example, the Mirkin Group of Skokie Ill., has developed synthesis strategies that can enable nanoparticle megalibrary formation. Scanning probe block copolymer lithography (SPBCL) is a tip-directed synthesis technique capable of preparing well-defined nanomaterials in terms of size and/or composition, wherein a scanning probe deposits a miniscule volume of nanoparticle precursor in a ‘nanoreactor,’ and the precursor atoms coalesce and coarsen into a single particle. The 2D parallelization of this synthesis strategy via polymer pen lithography (PPL) can allow the creation of 2D arrays of well-defined nanoparticles deposited by >90,000 tips acting in parallel. Certain inking and/or printing techniques can be used to create chemical and/or size gradients across the 2D nanoparticle arrays. The resultant megalibrary can contain >200,000,000 individual nanoparticles and >90,000 unique combinations of composition and size. This technique has been commercialized by Stoicheia, Inc., who is now poised to become the highest-throughput materials synthesis and discovery company in history.

While much of the synthetic risk has been mitigated over the last several years via advances in the Mirkin Group and Stoicheia, Inc., significant challenges remain in the extraction of meaningful data from nanoparticle megalibraries. For example, while an elemental map of a single nanoparticle can be readily acquired using energy dispersive X-ray spectroscopy (EDS), it may not be feasible for a human operator to repeat this process for every nanoparticle synthesized on a single chip (>200 million). To fully realize the potential of certain disclosed synthetic platform, automated techniques for nanoparticle characterization can be implemented.

Nanoparticle libraries or megalibraries are amenable to automated screening techniques, even at the single particle level, due to the spatial regularity (2D nanoparticle array with controlled interparticle distance) and spatially encoded structural properties (compositional/size gradients along particular axes).

Coupled with enhanced X-ray detection through the use of multiple detectors (>2) or design of an annular detector, automation of structural and compositional characterization of nanoparticle megalibraries via SEM can be implemented. Such an autonomous techniques can reduce the labor cost of library or megalibrary characterization and/or allow structure-property relationships to be made after catalytic screening. Additionally, a significant increase in the utility of SEM for nanoscale characterization can be achieved. Neither large-scale automation nor elemental mapping has been reliably achieved at this resolution (e.g., sub-nm) using SEM. Accordingly, such implementations can lead to major paradigm shifts in the characterization of such nanomaterials. In some embodiments, any suitable characterization/screening technique may be applied, including but not limited to atomic force microscopy (AFM), transmission electron microscopy (TEM), confocal microscopy, scanning Raman spectroscopy.

To screen catalytic activity of nanocatalyst patterns, several complementary high-throughput/high-resolution screening techniques can be used. Most notably, a scanning droplet electrochemical cell (SDC) instrument can be used to perform. CV scans in a droplet of continuously flowing electrolyte on the nanocatalyst chip. By non-limiting example, two reactions that are of great interest towards securing a net-zero carbon economy, the hydrogen evolution reaction (HER) and carbon dioxide reduction reaction (CO₂RR), can be screened in tandem simply by switching electrolyte and subtracting background HER in the case of CO₂RR.

For HER, onset potential, overpotential and/or current can be measured. Because there are no competing Faradaic processes at the potentials required for HER, these measurements can be directly correlated to catalyst activity. For CO₂RR overall activity can be measured by the same metrics after background HER is subtracted, but due to the multitude of competing pathways, selectivity cannot be measured simply by acquiring I-V curves. Concentrating and analyzing volatiles in the runoff electrolyte by IR/MS is a feasible method for high-throughput selectivity screening of CO₂RR.

Stability can be measured either by performing long/multiple experiments at each point, or by performing an initial SDC screen, subjecting to bulk electrolysis (i.e, in bulk electrolyte) for a certain time, and then performing another SDC screen to measure how catalyst performance changes at each point. A typical SDC instrument can have X-Y resolution of about <1 μm and can therefore raster across the catalyst at increments equivalent to the pitch of individual nanoparticle patterns (50 μm), or move in increments equivalent to the diameter of the droplet, only performing one measurement/material.

Referring to FIG. 1, an example of the guidance achieved by an AI-based controller is shown to illustrated the selective operation provided. A machine learning module can be implemented to provide guidance in the characterization operations. Such guidance can include intra-experiment optimization as discussed for SEM and SDC. For example, this may include real-time data analysis and decision making as to which location to probe next within a single chip and/or how of few data points are required to map the whole libraries properties accurately. Guidance may include inter-experiment optimization. For example, guidance may include deciding which library to make next. In some embodiments, the machine learning module may conduct convolution/deconvolution of overlapping/ensemble SDC measurements.

In FIG. 1, a number of representative set of data points 12 have been illustratively selected for consideration in sequence. For example, element 14 was initially selected, either arbitrarily or with some advanced input, as a first material sample for evaluation to detect information. The detected information can be used to define the functional characteristics of the same sample for correlation with known operational data of the sample collection. Element 16 is illustratively selected next for detection, followed by elements, 18, 20 as suggested by the pathway, in FIG. 1. However, the particular pathway and, thus, the next material sample in the sequence is merely illustrative and does not limit the manner of sequence of evaluation. As discussed in additional detail herein, the system may determine the location of the next material sample for evaluation actively or passively.

In the illustrative embodiment, the known operational data can include data concerning the physical, chemical, and/or treatment attributes of the set of materials. For example, the collection of material samples can include a priori knowledge of such attributes, such as physical size, chemical composition or precursors such as by sputter coating onto the substrate to create known material gradients, and/or treatments such as irradiating pre-determined portions of the samples on the substrate with different (known) wavelengths of light and/or exposure to various different (know) electro/magnetic fields to create a known treatment gradient.

Referring now to FIG. 2, a flow diagram illustrates operations within the present disclosure. In box 110, the sample set of the material collection is obtained. In the illustrative embodiment, obtaining the samples includes defining the library construct, for example, by positionally encoding the material samples on a substrate. In some embodiments, some or all of the set of material samples may be obtain from a pre-encoded library, and/or obtained as identifying the set of materials from which information is already known, and encoding the set may therefore be optional under known circumstances.

In box 112, definitional data of one or more samples is detected. In the illustrative embodiment, detection of definitional data includes evaluation of one sample, followed by another, in sequence. The detection of box 112 illustrative includes each individual sample evaluation, followed by an operational loop indicating detection concerning the next material sample. However, in some embodiments, detection of box 112 may include detection concerning more than one sample, for example, may include detection of two or more samples near to a certain location on the substrate as an exploration operation, e.g., random selection of two or more samples in the same general location to learn more about the region, and the operational loop indicates proceeding to another (general) location to detect information from one or more other material samples as an exploration operation where known information is considered and applied to determine the next-sample location as an affirmative decision. In some embodiments, exploration operation may include some informed location detection within a constrained sub-location-set of the materials samples, for example, within a band of statistically determined variation (e.g., two sigma) for one or more parameters.

Definitional data may include any suitable descriptive/functional information that can be observed concerning the material samples to be characterized. For example, definitional data can include electrochemical activity, chemical product distribution resultant from reaction, elemental distribution and/or geometry, mechanical properties, fluorescence intensity, catalytic activity, physical properties such as magnetic or electrical properties, thermal stability and/or expansion properties, optical properties, e.g., luminescence, plasmonic properties, etc., and/or dynamic evolution properties of structural and/or functional evolution in the process of catalysis and/or corrosion.

In box 114, correlation between the definitional data and operation data can be concluded. In some embodiments, correlation may be included as a part of detection in box 112. Correlation illustratively includes conducting statistical analysis of the definitional and operational data to determine relationship therebetween, for example, absolute error between measured and predicted current readout under well-defined process parameters.

In box 116, sample characterization can be conducted. In the illustrative embodiment, at least some of the samples from which definitional data was detected can be characterized as training data. Characterization as training data can include material characterization of the corresponding samples based on the correlation between some or all of the definitional data and the operational data. The training data can be applied in determining the next location of the sample(s) for characterization as training data for detection of definitional data, correlation, and/or characterization.

Determining the next-material sample for characterization as training data illustratively include determining the next-material sample for detection of definitional data for further characterization as training data. For example, upon characterizing of at least some of the definitional samples as training data, the training data can be entered into a machine learning model to provide, as an output, the location on the substrate for the next-material sample for consideration. In the illustrative embodiment, determining the location for the next-material sample for consideration includes determining a predicted output, determining an experimental output, and comparing the predicted and experimental outputs with each other. In some embodiments, the predicted output may be based on the a priori knowledge of the material sample at the corresponding location. The experimental outputs may include the detected values from detection of the definitional data as experimental testing of the sample at the relevant location. Comparing predicted and experimental outputs can illustratively include determining a predictive error value therebetween as a difference between the experimentally observed output and the predicted output. A confidence value can be determined based on the error value. For example, a confidence value can include a likelihood of reducing the error value based on detection occurring for one or more newly selected material sample locations on the substrate.

In some embodiments, other machine learning inputs may be applied to determine the next-material sample. For example, the machine learning model may include additional features, such as Generative Adversarial Networks (GANs) trained according to earlier definitional and/or operational data. The GANs can attempt to predict, for example, the physical or chemical structure of materials with the functional characteristics of interest, and may determine the location on the substrate corresponding to the predicted structure, may measure the performance of the sample at the predicted location, compare the measured value(s) to the predict value(s), adjust the GAN model based on discrepancy between measured and predicted value(s), and/or provide the next prediction.

Appropriate characterization data of the material collection may be determined upon sufficient credibility of the samples. In the illustrative example of a confidence interval, a predetermined threshold confidence value may be applied to determine appropriate characterization of the material collection. Once sufficient characterization data has been accumulated, the training data can be inputted into the machine learning model to output characterization of the entire material collection, including at least the portion of samples not yet characterized.

Referring now to FIG. 3, a material characterization system 22, in accordance with the disclosed embodiments, illustratively includes a data collection system 24 and characterization control system 26. The data collection system 24 illustratively includes a sensor 28 for determining definitional data from selected material samples of the material collection. The sensor 28 may comprise any one or more suitable analysis equipment, for example, for detection of visual (e.g., cameras, microscopy, thermal), chemical (e.g., products/reactants, process, electrochemical), and/or behavioral (e.g., light response, electro-magnetic response, frequency response) information.

The sensor 28 is illustratively/equipped with an armature 30 configured to move the focus of detection between samples of the collection. The armature 30 is illustratively embodied as a material platform for receiving the substrate thereon, the platform arranged for precision multiple axis movement through one or more motor-operators to selectively arrange each sample for inspection/detection by the sensor 28. In some embodiments, the sensor 28 may be mounted for movement on the armature 30 relative to stationary samples, and/or moved in conjunction therewith. The data collection system 24 includes a processor 32 for execution of instructions stored on memory 34, and communications circuitry 36 for sending and receiving instructions based on guidance from the processor 32 to conduct data collection system operations including at least detection, correlation, and guiding movement of the armature 30 for inspecting various samples, according to the techniques as disclosed herein.

The characterization control system 26 illustratively comprises a processor 38 for executing instructions stored on memory 40, and communications circuitry 42 for sending and receiving instructions based on guidance from the processor 38 to conduct characterization control system operations, including at least characterizing at least some definitional samples and inputting/outputting from the machine learning model illustrated as 44. The machine learning model 44 is illustratively comprised by the instructions stored on memory 40, but in some embodiments, may be wholly or partly embodied as a distinct system in communication with the control system 26. In some embodiments, the data collection control system 24 and characterization control system 28 may, partly or wholly, share processors, memories, and/or communication circuitry for conducting their operations.

Guidance may include role of signal to noise in SEM and/or SDC data. For example, guidance may include determination of threshold signal values and/or balancing acquisition rates and/or throughput for data quality. However, real-time operation via AI controller may require additional enhancement for robustness and/or scalability. For example, such enhancements may require consideration of compatibility with different stages of data collection (from small to large), the growing pool size of the ‘megalibraries’, and/or for responding to a wide range of possible design scenarios.

Within the present disclosure, devices, systems, and methods for material characterization may include automation of SEM and EDS data collection across nanoparticle libraries or megalibraries, demonstrating a mass-characterization library or megalibrary samples (and optionally confirming control over composition gradients); electrochemical screening for optimized catalyst for a key reactions (e.g., HER and CO₂RR using Cu, Au, Pt); and optimization of experimentation using both intra- and inter-experiment ML optimization. Accordingly, powerful combinatorial synthesis and screening platform for inorganic materials can be implemented.

With AI-assisted materials discovery, devices, systems, and methods within the present disclosure can reduce the characterization of millions of possible design combinations to only hundreds for a chosen material family that follows the similar physical principle or to thousands for multi-family explorations where the underlying physical behaviors are drastically, different. Such approaches can reduce the multi-year materials design cycle time to days. Within the present disclosure, many forms of materials may be considered, including but not limited to metals, metal oxides, metal sulfides, perovskites, and other hybrid materials, metal organic frameworks (MOFs).

Devices, systems, and/or methods within the present disclosure may implement control systems for their disclosed operations. Such control systems may include one or more processors embodied, for example, as microprocessors, memory for storing instructions for execution by the processors, and communications circuitry for conducting various operations according to the processors. Examples of suitable processors may include one or more microprocessors, integrated circuits, system-on-a-chips (SoC), among others. Examples of suitable memory, may include one or more primary storage and/or non-primary storage (e.g., secondary, tertiary, etc. storage); permanent, semi-permanent, and/or temporary storage; and/or memory storage devices including but not limited to hard drives (e.g., magnetic, solid state), optical discs (e.g., CD-ROM, DVD-ROM), RAM (e.g., DRAM, SRAM, DRDRAM), ROM (e.g., PROM, EPROM, EEPROM, Flash EEPROM), volatile, and/or non-volatile memory; among others. Communication circuitry may include components for facilitating processor operations, for example, suitable components may include transmitters, receivers, modulators, demodulators, filters, modems, analog/digital (AD or DA) converters, diodes, switches, operational amplifiers, and/or integrated circuits. AI and/or machine learning implementations may include instructions stored on the memory for execution by the processors for disclosed operations. AI and/or machine learning implementations may be embodied as one or more of neural networks, decision tree learning, regression analysis, Gaussian processes, Bayesian optimization and its associated acquisition functions, including any suitable manner of model, for example but without limitation, supervised, quasi-supervised, and/or unsupervised learning models, such as linear regression, logistic regression, decision tree, SVM, Naive Bayes, kNN, k-means, dimensionality reduction algorithms, gradient boosting algorithms (e.g., GBM, LightGBM, CatBoost) style models, GANs, and transformer models.

Accordingly, the various embodiments of the invention, as disclosed above, are intended to be illustrative, not limiting. Various changes may be made without departing from the spirit and scope of the invention. As a result, it will be apparent for those skilled in the art that the illustrative embodiments described are only examples and that various modifications can be made within the scope of the invention as defined in the appended claims.

1. A method of characterizing a material collection, the method comprising:
positionally encoding a set of material samples on at least one substrate according to known physical, chemical, and/or treatment attributes as operational data;
detecting definitional data from at least some of the material samples as definitional samples;
correlating the definitional data with the operational data;
characterizing at least some of the definitional samples as training data based on correlation of the definitional and the operational data, and
inputting the characterization training data to a machine learning model and outputting characterization of at least a portion of the set of material samples other than the definitional samples, based on the characterization training data.

2. The method of claim 1, wherein characterizing at least some of the definitional samples as training data includes determining, by the machine learning model, a location on the at least one substrate of a next-material sample for characterization as training data.

3. The method of claim 2, wherein determining the location on the at least one substrate of a next-material sample for characterization as training data includes determining a predicted output, determining an experimental output, and comparing the predicted and experimental outputs to determine a predictive error value, and determining a confidence value for predictive output of each of the material samples based on the predictive error value.

4. The method of claim 3, wherein determining the location on the at least one substrate of the next-material sample for characterization includes determination of the location on the at least one substrate of the next-material sample to increase the confidence value by the greatest amount.

5. The method of claim 4, wherein characterizing at least some of the definitional samples as training data is determined to be complete upon reaching a predetermined threshold confidence value.

6. The method of claim 2, wherein determining the location on the at least one substrate of a next-material sample for characterization as training data includes entering the training data into the machine learning model and outputting a next-location for detection and a predicted output of the corresponding sample, and detecting definitional data of the next-material sample and comparing the detected definitional data with the predicted output.

7. The method of claim 1, wherein physical chemical, and/or treatment attributes as operational data includes one or more of: precursor gradient among material samples across the at least one substrate, chemical constituent gradient among material samples across the at least one substrate, and treatment gradient by exposure to irradiation with different wavelengths among material samples across the at least one substrate.

8. The method of claim 1, wherein detecting definitional data includes determining one or more of catalytic activity, electrochemical activity, chemical product distribution resultant from reaction, elemental distribution and/or geometry, mechanical-physical properties, thermal properties, optical properties, catalytic and/or corrosion evolution, and/or fluorescence intensity.

9. The method of claim 1, further comprising determining one or more physical, chemical, and/or treatment attributes of a next material collection for further characterization.

10. The method of claim 1, wherein detecting definitional data further comprises obtaining definitional data concerning material samples of another known material collection as at least some of the definitional samples.

11. The method claim 1, wherein the material samples are each defined on the nano- or micro-scale.

12. The method claim 11, wherein detecting definitional data from at least some of the material samples includes moving between material samples at the nano- or micro-scale.

13. A material collection characterization system, the system comprising:
a data collection system comprising at least one sensor configured to detect definitional data from at least some material samples of a set of material samples as definitional samples, wherein the material samples are positionally encoded on at least one substrate according to known physical, chemical, and/or treatment attributes as operational data; and
a characterization control system comprising at least one processor configured to execute instructions stored on memory to conduct characterization of the set of material samples on the at least one substrate, the characterization control system configured to operate the data collection system to detect definitional data from at least some of the material samples as definitional samples, to correlate the definitional data with the operational data, and to characterize at least some of the definitional samples as training data based on the correlation of extracted definitional and operational data, wherein the characterization control system includes a machine learning model configured to receive the characterization training data as input, and to output characterization of at least a portion of the set of material samples other than the definitional samples, based on the characterization training data.

14. The system of claim 13, wherein configuration to characterize at least some of the definitional samples as training data includes configuration to determine, by the machine learning model, a location on the at least one substrate of a next-material sample for characterization as training data.

15. The system of claim 14, wherein configuration to determine the location on the at least one substrate of a next-material sample for characterization as training data includes configuration to determine a predicted output, to determine an experimental output, and to compare the predicted and experimental outputs for determining a predictive error value, and to determine a confidence value for predictive output of each of the material samples based on the predictive error value.

16. The system of claim 14, wherein configuration to determine the location on the at least one substrate of the next-material sample for characterization includes configuration to determine the location on the at least one substrate of the next-material sample for increasing the confidence value by the greatest amount.

17. The system of claim 15, wherein characterization of at least some of the definitional samples as training data is determined to be complete upon reaching a predetermined threshold confidence value.

18. The system of claim 14, wherein configuration to determine the location on the at least one substrate of a next-material sample for characterization as training data includes entering the training data into the machine learning model and outputting a next-location for detection and a predicted output of the corresponding sample, and detecting definitional data of the sample and comparing the detected definitional data with the predicted output.

19. The system of claim 13, wherein physical, chemical, and/or treatment attributes as operational data includes one or more of: precursor gradient among material samples across the at least one substrate, chemical constituent gradient among material samples across the at least one substrate, and treatment gradient by exposure to irradiation with different wavelengths among material samples across the at least one substrate.

20. The system of claim 13, wherein configuration to detect definitional data includes configuration to determine one or more of catalytic activity, electrochemical activity, chemical product distribution resultant from reaction, elemental distribution and/or geometry, mechanical-physical properties, thermal properties, optical properties, catalytic and/or corrosion evolution, and/or fluorescence intensity.

21. The system of claim 13, wherein the characterization control system is further configured to determine one or more parameters of a next material collection for further characterization.

22. The system of claim 13, wherein configuration to detect definitional data further comprises obtaining definitional data concerning material samples of another known material collection as at least some of the definitional samples.

23. The system claim 13, wherein the material samples are each defined on the nano- or micro-scale.

24. The system claim 13, wherein configuration to detect definitional data from at least some of the material samples includes configuration to position the data collection system to collect data of different material samples at the nano- or micro-scale.

25. A method of characterizing a material chip, the method comprising:
detecting definitional data from material samples as definitional samples, the material samples positionally encoded on a substrate according to known physical, chemical, and/or treatment attributes as operational data;
correlating the definitional data with the operational data, including correlating based on definitional data obtained from another material chip having materials samples positionally encoded on a substrate according to known physical, chemical, and/or treatment attributes as operational data;
characterizing at least some of the definitional samples as training data based on correlation of the definitional and the operational data; and
inputting the characterization training data to a machine learning model and outputting characterization of at least a portion of the set of material samples other than the definitional samples, based on the characterization training data.
